(19) United States
(12) Patent Application Publication
(10) Pub. No.: US 2026/0154510 A1
(43) Pub. Date: Jun. 4, 2026

(54) TERMINAL APPARATUS AND SYSTEM

(71) Applicant: NEC Corporation, Tokyo (JP)

(72) Inventor: Seiya SHIBATA, Tokyo (JP)

(73) Assignee: NEC Corporation, Tokyo (JP)

(21) Appl. No.: 19/398,684

(22) Filed: Nov. 24, 2025

(30) Foreign Application Priority Data
Nov. 29, 2024 (JP) 2024-208255

(51) Int. Cl. G06F 40/40

(52) U.S. Cl. CPC G06F 40/40

(57) ABSTRACT

A terminal apparatus includes a transmission unit for transmitting at least question information representing a question input by a user using an input apparatus to an information processing apparatus including a first language model for answering the question, a receiving unit for receiving, from the information processing apparatus, first answer information obtained by input of a first prompt into the first language model, the first prompt being generated by use of the question information and general information related to the question information, a prompt generation unit for generating a second prompt by using the question information, the first answer information, and secret information related to the question information set in advance, and an answer generation unit for generating second answer information by inputting the second prompt into a second language model.

### CROSS REFERENCE TO RELATED APPLICATION

This application is based upon and claims the benefit of priority from Japanese patent application No. 2024-208255, filed on Nov. 29, 2024, the disclosure of which is incorporated herein in its entirety by reference.

### TECHNICAL FIELD

The present disclosure relates to a terminal apparatus using a language model, an information processing method, and a computer-readable recording medium.

### BACKGROUND ART

Conventionally, in a system that obtains an answer to a question by using a large-scale language model, an answer is obtained by use of secret information (for example, private information, sensitive information, and the like) stored on a cloud. However, since there is a risk of leakage, users want to avoid putting secret information on the cloud as much as possible.

Thus, it is conceivable to perform processing using a large-scale language model on a terminal apparatus side. However, since an amount of processing by a terminal apparatus increases and the terminal apparatus operates at a low speed, there is a possibility that a time until an answer is obtained increases. In a case where an operation speed of the terminal apparatus is improved and accuracy of the answer is set to be similar to that of the cloud, size of hardware of the terminal apparatus increases. On the other hand, in a case where the size of the hardware of the terminal apparatus is maintained as it is and the operation speed is improved, the accuracy of the answer decreases.

As a related technique, PTL 1 (JP 2020-198043 A) discloses a terminal apparatus that performs highly accurate character recognition processing at low cost and reduces a risk of leakage of secret information. According to the terminal apparatus of JP 2020-198043 A, a document image is separated into a personal information image including personal information and a general information image not including the personal information based on the document image including the personal information, and the general information image is transmitted to a cloud server. The terminal apparatus receives a general recognition result that is a recognition result of the character recognition processing on the general information image from the cloud server, and acquires a recognition result of the character recognition processing on the document image according to the general recognition result and information based on the personal information image.

However, in the terminal apparatus of JP 2020-198043 A, since a processed image obtained by processing the personal information separated from the document image is transmitted to a character recognition processing apparatus, there is a possibility that the processed image is decrypted on the cloud side (there is a possibility that secret information is leaked).

### SUMMARY

An example of an object of the present disclosure is to handle secret information only on a terminal apparatus side and to reduce an amount of processing by a terminal apparatus, in processing using a language model.

In order to achieve the above object, a terminal apparatus according to one aspect of the present disclosure

is characterized in that the terminal apparatus includes

a transmission unit for transmitting at least question information representing a question input by a user using an input apparatus to an information processing apparatus including a first language model for answering the question,

a receiving unit for receiving, from the information processing apparatus, first answer information obtained by input of a first prompt into the first language model, the first prompt being generated by use of the question information and general information related to the question information,

a prompt generation unit for generating a second prompt by using the question information, the first answer information, and secret information related to the question information set in advance, and

an answer generation unit for generating second answer information by inputting the second prompt into a second language model.

In order to achieve the above object, an information processing method according to one aspect of the present disclosure

is characterized in that the information processing method includes,

by a computer,

transmitting at least question information representing a question input by a user using an input apparatus to an information processing apparatus including a first language model for answering the question,

receiving, from the information processing apparatus, first answer information obtained by input of a first prompt into the first language model, the first prompt being generated by use of the question information and general information related to the question information,

generating a second prompt by using the question information, the first answer information, and secret information related to the question information set in advance, and

generating second answer information by inputting the second prompt into a second language model.

In order to achieve the above object, a computer-readable recording medium according to one aspect of the present disclosure

is characterized in that the computer-readable recording medium causes

a computer to

transmit at least question information representing a question input by a user using an input apparatus to an information processing apparatus including a first language model for answering the question,

receive, from the information processing apparatus, first answer information obtained by input of a first prompt into the first language model, the first prompt being generated by use of the question information and general information related to the question information,

generate a second prompt by using the question information, the first answer information, and secret information related to the question information set in advance, and

generate second answer information by inputting the second prompt into a second language model.

Furthermore, in order to achieve the above object, a system according to one aspect of the present disclosure

is characterized in that,

a terminal apparatus transmits at least question information representing a question input by a user using an input apparatus to a server apparatus including a first language model for answering the question,

the server apparatus

receives the question information from the terminal apparatus,

generates a first prompt by using the question information and general information related to the question information,

generates first answer information by inputting the first prompt into the first language model, and

transmits the first answer information to the terminal apparatus, and

the terminal apparatus

receives the first answer information from the server apparatus,

generates a second prompt by using the question information, the first answer information, and secret information related to the question information set in advance, and

generates second answer information by inputting the second prompt into a second language model.

In order to achieve the above object, a terminal apparatus according to one aspect of the present disclosure

is characterized in that the terminal apparatus includes

a transmission unit for transmitting at least question information representing a question input by a user using an input apparatus to an information processing apparatus including a first language model for answering the question,

a receiving unit for receiving cache information and general information from the information processing apparatus, the cache information being generated when first answer information is generated by input of a first prompt into the first language model and read from a memory used for the first language model, the first prompt being generated by use of the question information and the general information related to the question information,

a writing unit for writing the cache information to a memory used for a second language model,

a prompt generation unit for generating a second prompt by using the question information, the general information, and secret information related to the question information set in advance, and

an answer generation unit for generating second answer information by inputting the second prompt into the second language model.

In order to achieve the above object, an information processing method according to one aspect of the present disclosure

is characterized in that the information processing method includes,

by a computer,

transmitting at least question information representing a question input by a user using an input apparatus to an information processing apparatus including a first language model for answering the question,

receiving cache information and general information from the information processing apparatus, the cache information being generated when first answer information is generated by input of a first prompt into the first language model and read from a memory used for the first language model, the first prompt being generated by use of the question information and the general information related to the question information,

writing the cache information to a memory used for a second language model,

generating a second prompt by using the question information, the general information, and secret information related to the question information set in advance, and

generating second answer information by inputting the second prompt into the second language model.

In order to achieve the above object, a computer-readable recording medium according to one aspect of the present disclosure

is characterized in that the computer-readable recording medium causes

a computer to

transmit at least question information representing a question input by a user using an input apparatus to an information processing apparatus including a first language model for answering the question,

receive cache information and general information from the information processing apparatus, the cache information being generated when first answer information is generated by input of a first prompt into the first language model and read from a memory used for the first language model, the first prompt being generated by use of the question information and the general information related to the question information,

write the cache information to a memory used for a second language model,

generate a second prompt by using the question information, the general information, and secret information related to the question information set in advance, and

generate second answer information by inputting the second prompt into the second language model.

Furthermore, in order to achieve the above object, a system according to one aspect of the present disclosure

is characterized in that,

a terminal apparatus transmits at least question information representing a question input by a user using an input apparatus to a server apparatus including a first language model for answering the question,

the server apparatus

receives the question information from the terminal apparatus,

generates a first prompt by using the question information and general information related to the question information,

generates first answer information by inputting the first prompt into the first language model,

reads cache information from a memory used for the first language model, the cache information being generated when the first answer information is generated, and

transmits the cache information and the general information to the terminal apparatus, and

the terminal apparatus

receives the cache information and the general information from the server apparatus,

writes the cache information to a memory used for a second language model,

generates a second prompt by using the question information, the general information, and secret information related to the question information set in advance, and

generates second answer information by inputting the second prompt into the second language model.

As described above, according to the present disclosure, it is possible to handle the secret information only on the terminal apparatus side, and reduce the amount of processing by the terminal apparatus, in the processing using the language model.

### BRIEF DESCRIPTION OF THE DRAWINGS

FIG. 1 is a diagram for describing an example of a terminal apparatus of a first example embodiment;

FIG. 2 is a diagram for describing an example of a system including the terminal apparatus of the first example embodiment;

FIG. 3 is a diagram for describing an example of operation of the terminal apparatus of the first example embodiment;

FIG. 4 is a diagram for describing an example of operation of an information processing apparatus (server apparatus) of the first example embodiment;

FIG. 5 is a diagram for describing an example of operation of the system of the first example embodiment;

FIG. 6 is a diagram for describing an example of a terminal apparatus of a second example embodiment;

FIG. 7 is a diagram for describing an example of a system including the terminal apparatus of the second example embodiment;

FIG. 8 is a diagram for describing an example of operation of the terminal apparatus of the second example embodiment;

FIG. 9 is a diagram for describing an example of operation of an information processing apparatus (server apparatus) of the second example embodiment;

FIG. 10 is a diagram for describing an example of operation of the system of the second example embodiment; and

FIG. 11 is a diagram for describing an example of a computer that implements the terminal apparatus and the information processing apparatus (server apparatus) in the first and second example embodiments.

### EXAMPLE EMBODIMENT

Hereinafter, an example embodiment will be described with reference to the drawings. In the drawings described below, elements having the same function or relevant functions are denoted by the same reference signs, and repeated description thereof may be omitted.

### First Example Embodiment

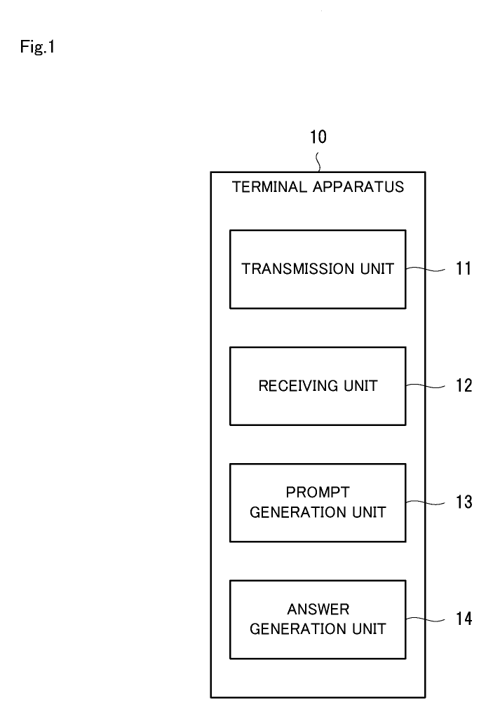

A configuration of a terminal apparatus in a first example embodiment will be described with reference to FIG. 1. FIG. 1 is a diagram for describing an example of the terminal apparatus of the first example embodiment.

### Apparatus Configuration

The terminal apparatus illustrated in FIG. 1 is an apparatus that handles secret information only on the terminal apparatus side and reduces an amount of processing by the terminal apparatus, in processing using a language model. As illustrated in FIG. 1, a terminal apparatus 10 includes a transmission unit 11, a receiving unit 12, a prompt generation unit 13, and an answer generation unit 14.

The transmission unit 11 transmits at least question information representing a question input by a user using an input apparatus to an information processing apparatus (server apparatus) including a first language model for outputting an answer to the question.

The receiving unit 12 receives, from the information processing apparatus, first answer information obtained by input of a first prompt into the first language model, the first prompt being generated by use of the question information and general information related to the question information.

The prompt generation unit 13 generates a second prompt by using the question information, the first answer information, and secret information related to the question information set in advance.

The answer generation unit 14 generates second answer information by inputting the second prompt into a second language model.

As described above, in the first example embodiment, in the processing using the language model, the secret information is handled by the terminal apparatus without being transmitted to a cloud side (information processing apparatus (server apparatus)), so that it is possible to prevent leakage of the secret information.

Furthermore, the cloud side first acquires the first answer information by using the question information and the general information, and the terminal apparatus side acquires the second answer information by using the question information, the first answer information, and the secret information, so that it is possible to reduce the amount of processing of the language model by the terminal apparatus.

### System Configuration

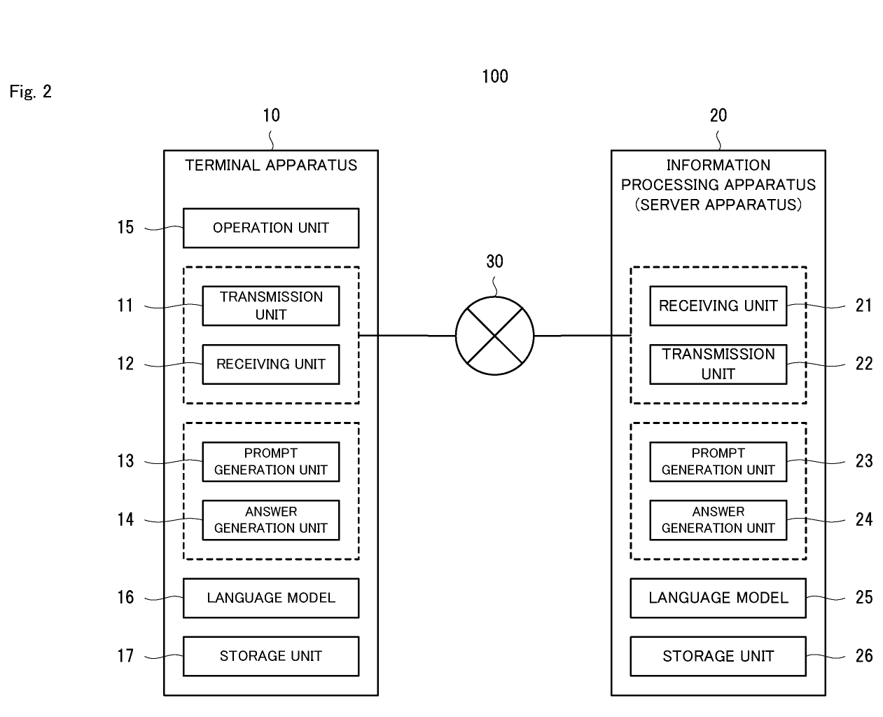

Subsequently, a configuration of the terminal apparatus 10 in the first example embodiment will be more specifically described with reference to FIG. 2. FIG. 2 is a diagram for describing an example of a system including the terminal apparatus of the first example embodiment.

As illustrated in FIG. 2, a system 100 in the first example embodiment includes the terminal apparatus 10, an information processing apparatus 20 (server apparatus), and a network 30.

The terminal apparatus 10 is an information processing apparatus provided on an edge side, for example, a circuit, a server computer, a personal computer, a mobile terminal, or the like equipped with a central processing unit (CPU), a programmable device such as a field-programmable gate array (FPGA), a graphics processing unit (GPU), or any one or more of them.

The information processing apparatus 20 (server apparatus) is an information processing apparatus provided on the cloud side, for example, a circuit, a server computer, or the like equipped with a CPU, a programmable device such as an FPGA, a GPU, or any one or more of them.

The network 30 is a general network constructed by use of a communication line, for example, the Internet, a local area network (LAN), a dedicated line, a telephone line, an intra-company network, a mobile communication network, Bluetooth (registered trademark), Wireless Fidelity (Wi-Fi) (registered trademark), or the like.

The terminal apparatus will be described in detail.

The terminal apparatus 10 includes an operation unit 15, the transmission unit 11, the receiving unit 12, the prompt generation unit 13, the answer generation unit 14, a language model 16, and a storage unit 17.

The operation unit 15 is a user interface or the like for inputting a question by using an input apparatus, for example, a touch panel, a mouse, or a keyboard provided in the terminal apparatus 10. However, the operation unit 15 may be provided outside the terminal apparatus 10.

First, the transmission unit 11 acquires at least the question information (R: request) representing a question input by the user using the operation unit 15. Next, the transmission unit 11 performs transmission to the information processing apparatus 20 (server apparatus) including a language model 25 (first language model: LLM1) for answering a question, which will be described later.

The receiving unit 12 receives, from the information processing apparatus 20, the first answer information (A1 = LLM1(prompt1)) obtained by input of the first prompt (prompt1 = G + R) into the language model 25 (LLM1), the first prompt being generated by use of the question information (R) and the general information (G: general) related to the question information (R).

The general information (G) is information stored in advance in a storage unit 26 described later. The general information (G) is, for example, information that causes no problem even if the information leaks to the outside.

By using the question information (R), the first answer information (A1), and the secret information (P: private) related to the question information set in advance, the prompt generation unit 13 generates second prompt (prompt2 = R + A1 + P).

The secret information (P) is information stored in advance in the storage unit 17. The secret information (P) is, for example, information that should not be leaked to the outside.

By inputting the second prompt (prompt2) into the language model 16 (second language model: LLM2), the answer generation unit 14 generates the second answer information (A2 = LLM2(prompt2)).

The language model 16 (LLM2) is, for example, a large-scale language model or the like. As the large-scale language model, for example, a Self-Attention based large-scale language model or the like can be considered. However, the present system is not limited to the above-described large-scale language model.

A configuration of the language model 16 is not limited, and may be equivalent to or different from that of the language model 25.

The storage unit 17 is a circuit or the like including a memory. The storage unit 17 stores information, for example, at least the secret information (P) or the like. In the example of FIG. 2, the storage unit 17 is provided inside the terminal apparatus 10, but may be provided outside the terminal apparatus 10.

The information processing apparatus (server apparatus) will be described in detail.

The information processing apparatus 20 includes a receiving unit 21, a transmission unit 22, a prompt generation unit 23, an answer generation unit 24, the language model 25, and the storage unit 26.

The receiving unit 21 receives the question information (R) from the terminal apparatus 10 via the network 30.

By using the question information (R) received and the general information (G) related to the question information (R), the prompt generation unit 23 generates the first prompt (prompt1 = G + R).

By inputting the first prompt (prompt1 = G + R) into the language model 25 (LLM1), the answer generation unit 24 generates the first answer information (A1 = LLM1(prompt1)).

The language model 25 (LLM1) is, for example, a large-scale language model or the like. As the large-scale language model, for example, a Self-Attention based large-scale language model or the like can be considered. However, the present system is not limited to the above-described large-scale language model.

The transmission unit 22 transmits the first answer information (A1) to the terminal apparatus 10 via the network 30.

The storage unit 26 is a circuit or the like including a memory. The storage unit 26 stores information, for example, at least the general information or the like. In the example of FIG. 2, the storage unit 26 is provided inside the information processing apparatus (server apparatus) 20, but may be provided outside the information processing apparatus 20. In that case, for example, a database, a server computer, or the like can be considered.

### Apparatus Operation

Operation of the terminal apparatus will be described in detail.

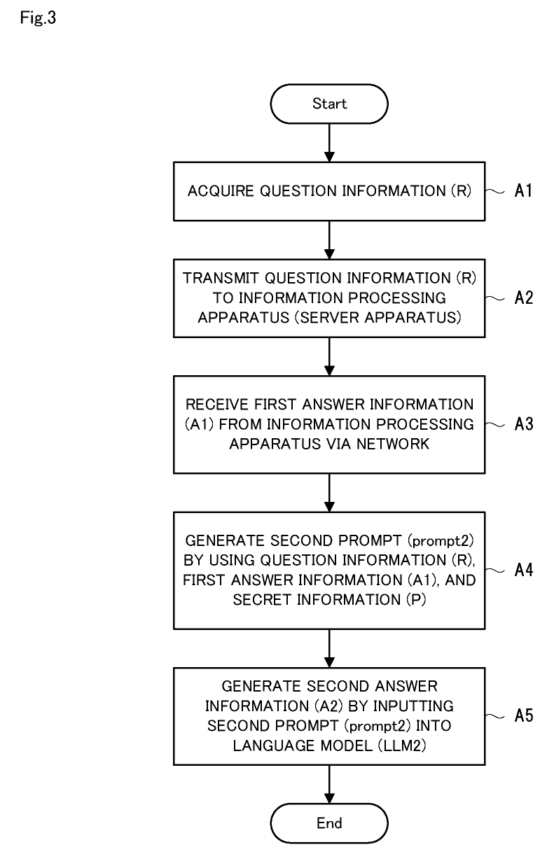

Next, the operation of the terminal apparatus in the first example embodiment will be described with reference to FIG. 3. FIG. 3 is a diagram for describing an example of operation of the terminal apparatus of the first example embodiment. The drawing will be appropriately referred to in the following description. In the first example embodiment, the terminal apparatus is caused to operate, whereby an information processing method of the terminal apparatus is implemented. Thus, description of the information processing method in the first example embodiment is substituted with the description of the operation of the terminal apparatus below.

As illustrated in FIG. 3, the transmission unit 11 first acquires at least the question information (R) representing a question input by the user using the operation unit 15 (step A1).

Next, the transmission unit 11 transmits the question information (R) to the information processing apparatus 20 (server apparatus) including the language model 25 (first language model: LLM1) for answering the question (step A2).

Next, the receiving unit 12 receives, from the information processing apparatus 20 via the network 30, the first answer information (A1 = LLM1(prompt1)) obtained by input of the first prompt (prompt1 = G + R) into the language model 25 (LLM1), the first prompt being generated by use of the question information (R) and general information (G: general) related to the question information (R) (step A3).

Next, by using the question information (R), the first answer information (A1), and the secret information (P) related to the question information set in advance, the prompt generation unit 13 generates the second prompt (prompt2 = R + A1 + P) (step A4).

Next, by inputting the second prompt (prompt2) into the language model 16 (LLM2), the answer generation unit 14 generates the second answer information (A2 = LLM2(prompt2)) (step A5). Thereafter, the second answer information (A2) is presented to the user by use of the user interface of the terminal apparatus 10.

Operation of the information processing apparatus (server apparatus) will be described in detail.

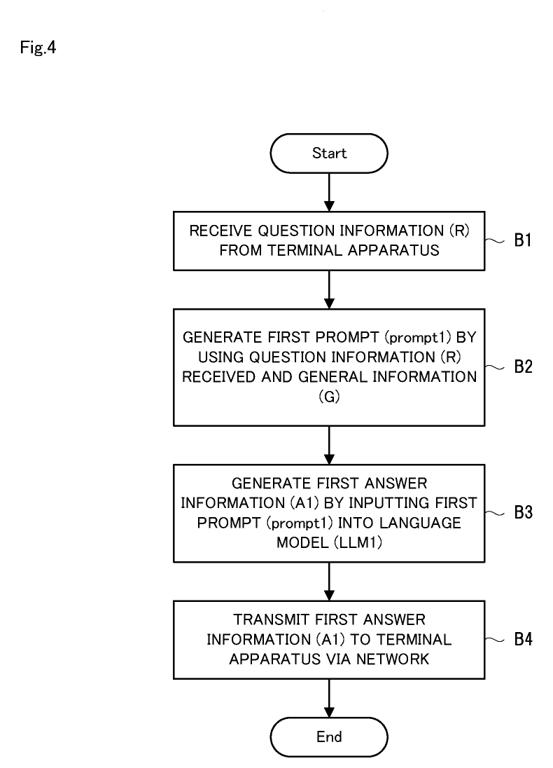

Next, operation of the information processing apparatus (server apparatus) in the first example embodiment will be described with reference to FIG. 4. FIG. 4 is a diagram for describing an example of the operation of the information processing apparatus (server apparatus) of the first example embodiment. The drawing will be appropriately referred to in the following description. In the first example embodiment, the information processing apparatus (server apparatus) is caused to operate, whereby the information processing method of the information processing apparatus (server apparatus) is implemented. Thus, description of the information processing method in the first example embodiment is substituted with the description of the operation of the information processing apparatus (server apparatus) below.

First, the receiving unit 21 receives the question information (R) from the terminal apparatus 10 via the network 30 (step B1).

Next, by using the question information (R) received and the general information (G) related to the question information (R), the prompt generation unit 23 generates the first prompt (prompt1 = G + R) (step B2).

Next, by inputting the first prompt (prompt1 = G + R) into the language model 25 (LLM1), the answer generation unit 24 generates the first answer information (A1 = LLM1(prompt1)) (step B3).

Next, the transmission unit 22 transmits the first answer information (A1) to the terminal apparatus 10 via the network 30 (step B4).

### Effects of First Example Embodiment

As described above, according to the first example embodiment, in the processing using the language model, the secret information is handled by the terminal apparatus without being transmitted to the cloud side (information processing apparatus (server apparatus)), so that it is possible to prevent leakage of the secret information.

Furthermore, the cloud side first acquires the first answer information by using the question information and the general information, and the terminal apparatus side acquires the second answer information by using the question information, the first answer information, and the secret information, so that it is possible to reduce the amount of processing of the language model by the terminal apparatus.

### First Example

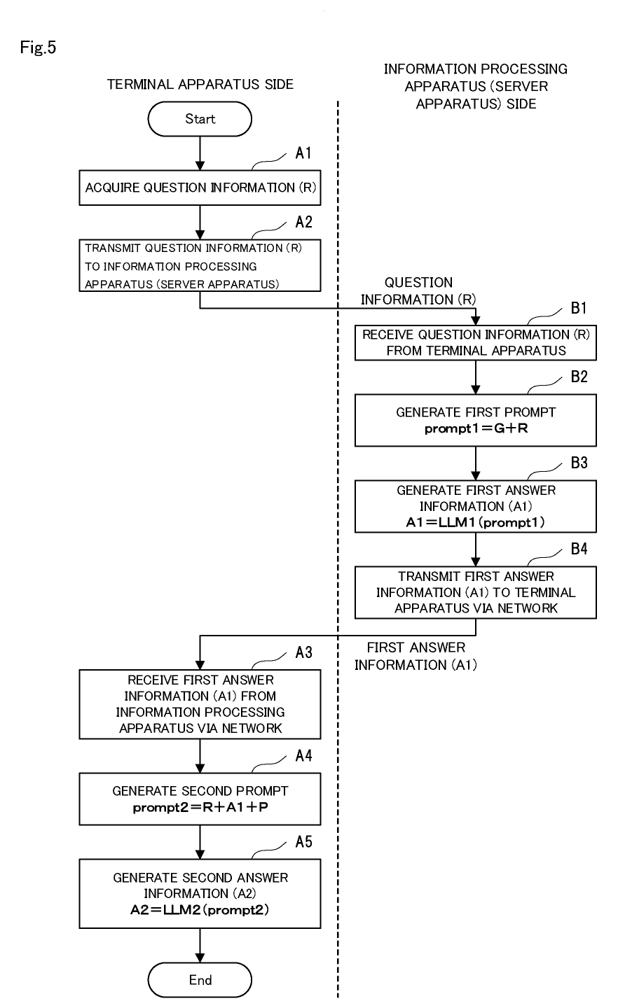

In a first example, with reference to FIG. 5, a description will be given of a case of requesting a determination in consideration of laws and further in consideration of company regulations. FIG. 5 is a diagram for describing an example of operation of the system of the first example embodiment.

Specifically, the general information (G) is a legal document database (DB) stored in advance in the storage unit 26. The legal document DB is, for example, enormous data of equal to or more than 60,000 words. The secret information (P) is a company regulation database (DB) stored in advance in the storage unit 17. The company regulation DB is data of, for example, 1000 words or the like.

In step A1, first, it is assumed that “Please tell me what I should be careful about when I want to do a side business” (17 words) is input as a question by use of the operation unit 15 of the terminal apparatus 10.

Next, in step A2, the transmission unit 11 of the terminal apparatus 10 transmits the question information (R) relevant to the question to the information processing apparatus 20 (server apparatus) via the network 30.

Next, in step B1, the receiving unit 21 of the information processing apparatus 20 (server apparatus) receives the question information (R) from the terminal apparatus 10 via the network 30.

Next, in step B2, by using the question information (R) received and the general information (G) related to the question information (R), the prompt generation unit 23 of the information processing apparatus 20 (server apparatus) generates the first prompt (prompt1 = G + R).

For example, a text in which legal documents related to tax return are cut out and listed for each of items is set as the general information (G), and “Please tell me what I should be careful about when I want to do a side business” that is the question input into the terminal apparatus 10 is used as the question information (R). However, the first prompt is not limited to the above-described content.

Next, in step B3, by inputting the first prompt (prompt1 = G + R) into the language model 25 (LLM1), the answer generation unit 24 of the information processing apparatus 20 (server apparatus) generates the first answer information (A1 = LLM1(prompt1)). The first answer information is, for example, “Tax return or the like... ” (200 words) or the like.

Next, in step B4, the transmission unit 22 of the information processing apparatus 20 (server apparatus) transmits the first answer information (A1) to the terminal apparatus 10 via the network 30.

Next, in step A3, the receiving unit 12 of the terminal apparatus 10 receives the first answer information (A1 = LLM1(prompt1)) from the information processing apparatus 20.

Next, in step A4, by using the question information (R), the first answer information (A1), and the secret information (P) related to the question information set in advance, the prompt generation unit 13 of the terminal apparatus 10 generates the second prompt (prompt2 = R + A1 + P).

For example, “Please tell me what I should be careful about when I want to do a side business” is set as the question information (R) similarly to the first prompt, a text “You need to file a tax return if you get salary from two or more employers” obtained from the language model 25 (LLM1) is used as it is as the first answer information (A1), and a text in which documents of work rules are listed is set as the secret information (P), and then the second prompt is generated. However, the second prompt is not limited to the above-described content.

Next, in step A5, by inputting the second prompt (prompt2) into the language model 16 (LLM2), the answer generation unit 14 of the terminal apparatus 10 generates the second answer information (A2 = LLM2(prompt2)).

The first answer information is, for example, “In addition to the final tax return, it is necessary, in the company, to apply for doing a side business... ” or the like.

As described above, the secret information (P) is handled by the terminal apparatus 10 without being transmitted to the cloud side (information processing apparatus (server apparatus)), so that it is possible to prevent leakage of the secret information.

Conventionally, all processing is executed on the information processing apparatus (server apparatus) side on a cloud, so that a conventional prompt (prompt) is generated by use of the general information (G), the question information (R), and the secret information (P) (prompt = G + R + P). Thus, the number of words in the conventional prompt is 61025. Then, when processing of the conventional prompt (prompt) is performed on the terminal apparatus side, the amount of processing of the language model increases.

However, by doing as in the first example embodiment, it is possible to reduce the amount of processing of the language model on the terminal apparatus 10 side. Specifically, on the information processing apparatus 20 (server apparatus) side on the cloud, the first prompt (prompt1 = G + R: 60025 words) is generated, and the first answer information (A1) is generated by use of the first prompt (prompt1). There is no problem even if the amount of processing of the language model is large on the information processing apparatus 20 (server apparatus) side on the cloud. Unlike conventional cases, the first prompt (prompt1) does not include the secret information (P).

Furthermore, since the terminal apparatus 10 side acquires the second answer information (A2) by using the first answer information (A1), the question information (R), and the secret information (P), it is possible to reduce the amount of processing of the language model on the terminal apparatus 10 side. Specifically, since the number of words of the second prompt (prompt2 = A1 + R + P) generated on the terminal apparatus 10 side is, for example, about 1225 words, it is possible to reduce the amount of processing of the language model on the terminal apparatus 10 side.

### Program

A program of the terminal apparatus will be described.

A program of the terminal apparatus in the first example embodiment only needs to be a program that causes a computer to execute steps A1 to A5 illustrated in FIG. 3. The program is installed on the computer and executed, whereby it is possible to implement the terminal apparatus and the information processing method in the first example embodiment. In this case, a processor of the computer functions as the prompt generation unit 13, the answer generation unit 14, the operation unit 15, and the language model 16, and performs processing.

The program of the terminal apparatus in the first example embodiment may be executed by a computer system including a plurality of computers. In this case, for example, each computer may function as any of the prompt generation unit 13, the answer generation unit 14, the operation unit 15, and the language model 16.

A program of the information processing apparatus (server apparatus) will be described.

A program of the information processing apparatus (server apparatus) in the first example embodiment only needs to be a program that causes a computer to execute steps B1 to B4 illustrated in FIG. 4. The program is installed on the computer and executed, whereby it is possible to implement the information processing apparatus (server apparatus) and the information processing method in the first example embodiment. In this case, a processor of the computer functions as the prompt generation unit 23, the answer generation unit 24, and the language model 25, and performs processing.

The program of the terminal apparatus in the first example embodiment may be executed by a computer system including a plurality of computers. In this case, for example, each computer may function as any of the prompt generation unit 23, the answer generation unit 24, and the language model 25.

### Second Example Embodiment

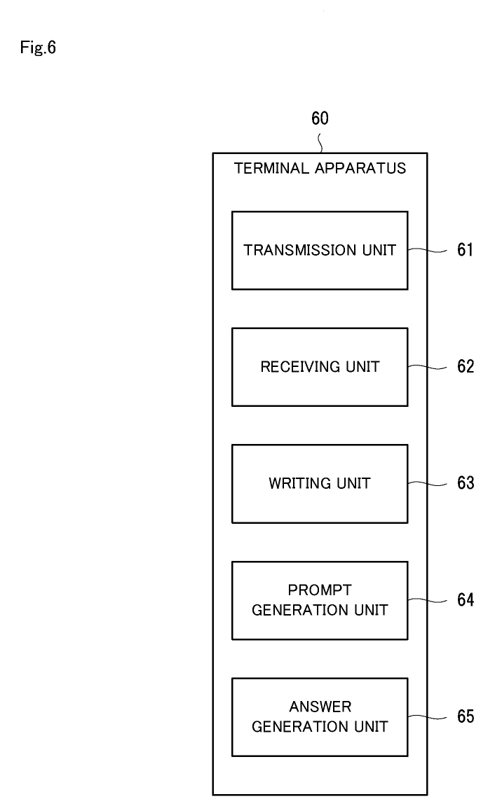

A configuration of a terminal apparatus in a second example embodiment will be described with reference to FIG. 6. FIG. 6 is a diagram for describing an example of the terminal apparatus of the second example embodiment.

### Apparatus Configuration

The terminal apparatus illustrated in FIG. 6 is an apparatus that handles secret information only on the terminal apparatus side and reduces an amount of processing by the terminal apparatus, in processing using a language model. As illustrated in FIG. 6, a terminal apparatus 60 includes a transmission unit 61, a receiving unit 62, a writing unit 63, a prompt generation unit 64, and an answer generation unit 65.

The transmission unit 61 transmits at least question information representing a question input by a user using an input apparatus to an information processing apparatus (server apparatus) including a first language model for outputting an answer to the question.

The receiving unit 62 receives cache information and the general information from the information processing apparatus, the cache information being generated when first answer information is generated by input of a first prompt into the first language model and read from a memory used for the first language model, the first prompt being generated by use of the question information and the general information related to the question information. The generation of the first answer information may be terminated halfway. The cache information may be used that is constructed by the time when the answer information is output.

The writing unit 63 writes the cache information to a memory used for a second language model.

The prompt generation unit 64 generates a second prompt by using the question information, the general information, and the secret information related to the question information set in advance.

The answer generation unit 65 generates second answer information by inputting the second prompt into the second language model.

As described above, in the second example embodiment, in the processing using the language model, the secret information is handled by the terminal apparatus without being transmitted to a cloud side (information processing apparatus (server apparatus)), so that it is possible to prevent leakage of the secret information.

On the cloud side, first, the first answer information is calculated by use of the question information and the general information, and information (cache information) in the memory (KV cache) used for the first language model, the information being generated when the first answer information is generated, is written to the memory (KV cache) used for the second language model of the terminal apparatus, so that it is possible to reduce the amount of processing for generating the cache information again on the terminal apparatus side.

### System Configuration

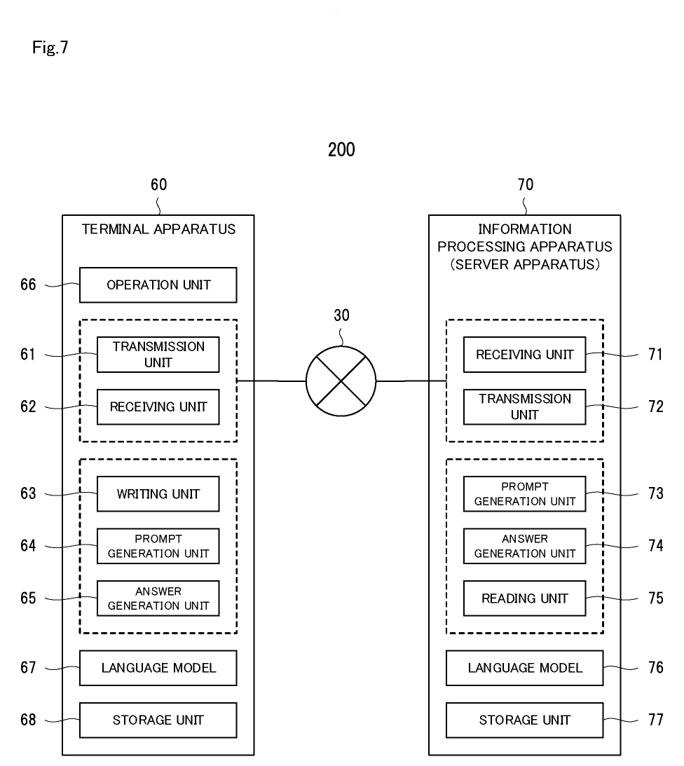

Subsequently, a configuration of the terminal apparatus 60 in the second example embodiment will be more specifically described with reference to FIG. 7. FIG. 7 is a diagram for describing an example of a system including the terminal apparatus of the second example embodiment.

As illustrated in FIG. 7, a system 200 in the second example embodiment includes the terminal apparatus 60, an information processing apparatus 70 (server apparatus), and the network 30.

The terminal apparatus 60 is an information processing apparatus provided on an edge side, for example, a circuit, a server computer, a personal computer, a mobile terminal, or the like equipped with a central processing unit (CPU), a programmable device such as a field-programmable gate array (FPGA), a graphics processing unit (GPU), or any one or more of them.

The information processing apparatus 70 (server apparatus) is an information processing apparatus provided on the cloud side, for example, a circuit, a server computer, or the like equipped with a CPU, a programmable device such as an FPGA, a GPU, or any one or more of them.

The network 30 is a general network constructed by use of a communication line, for example, the Internet, a local area network (LAN), a dedicated line, a telephone line, an intra-company network, a mobile communication network, Bluetooth (registered trademark), Wireless Fidelity (Wi-Fi) (registered trademark), or the like.

The terminal apparatus will be described in detail.

The terminal apparatus 60 includes an operation unit 66, the transmission unit 61, the receiving unit 62, the writing unit 63, the prompt generation unit 64, the answer generation unit 65, a language model 67, and a storage unit 68.

The operation unit 66 is a user interface or the like for inputting a question by using an input apparatus, for example, a touch panel, a mouse, or a keyboard provided in the terminal apparatus 60. However, the operation unit 66 may be provided outside the terminal apparatus 60.

First, the transmission unit 61 acquires at least the question information (R: request) representing a question input by the user using the operation unit 66. Next, the transmission unit 61 performs transmission to the information processing apparatus 70 (server apparatus) including a language model 76 (first language model: LLM1) for answering a question, which will be described later.

The receiving unit 62 receives the cache information (C: cache) and the general information (G: general) from the information processing apparatus 70, the cache information being generated when the first answer information (A1 = LLM1(prompt1)) is generated by input of the first prompt (prompt1 = G + R) into the language model 76 (LLM1) and read from the memory used for the language model 76, the first prompt being generated by use of the question information (R) and the general information (G) related to the question information (R).

The writing unit 63 writes the cache information (C) to the memory used for the language model 67 (second language model: LLM2).

The first language model (LLM1) and the second language model (LLM2) are identical language models. The cache information (C) is information stored in a KV cache used in the first language model (LLM1).

By using the question information (R), the general information (G), and the secret information (P: private) related to the question information set in advance, the prompt generation unit 64 generates the second prompt (prompt2 = G + R + P). Since beginning parts of the first prompt (prompt1) and the second prompt (prompt2) are both G + R and match each other, in the identical language models, sharing the cache information (C) can reduce processing.

By inputting the second prompt (prompt2) into the language model 67 (second language model: LLM2), the answer generation unit 65 generates the second answer information (A2 = LLM2(prompt2)).

The language model 67 (LLM2) is, for example, a large-scale language model or the like. As the large-scale language model, for example, a Self-Attention based large-scale language model or the like can be considered. However, the present system is not limited to the above-described large-scale language model.

The storage unit 68 is a circuit or the like including a memory. The storage unit 68 stores information, for example, at least the secret information (P) or the like. In the example of FIG. 7, the storage unit 68 is provided inside the terminal apparatus 60, but may be provided outside the terminal apparatus 60.

The information processing apparatus (server apparatus) will be described in detail.

The information processing apparatus 70 includes a receiving unit 71, a transmission unit 72, a prompt generation unit 73, an answer generation unit 74, a reading unit 75, the language model 76, and a storage unit 77.

The receiving unit 71 receives the question information (R) from the terminal apparatus 60 via the network 30.

By using the question information (R) received and the general information (G) related to the question information (R), the prompt generation unit 73 generates the first prompt (prompt1 = G + R).

By inputting the first prompt (prompt1 = G + R) into the language model 76 (LLM1), the answer generation unit 74 generates the first answer information (A1 = LLM1(prompt1)).

The language model 76 (LLM1) is, for example, a large-scale language model or the like. As the large-scale language model, for example, a Self-Attention based large-scale language model or the like can be considered. However, the present system is not limited to the above-described large-scale language model.

The reading unit 75 reads the cache information (C) from the memory used for the language model 76 (LLM1), the cache information being generated when the first answer information (A1) is generated.

The transmission unit 72 transmits the cache information (C) and the general information (G) to the terminal apparatus 60 via the network 30.

The storage unit 77 is a circuit or the like including a memory. The storage unit 77 stores information, for example, at least the general information or the like. In the example of FIG. 7, the storage unit 77 is provided inside the information processing apparatus (server apparatus) 70, but may be provided outside the information processing apparatus 70. In that case, for example, a database, a server computer, or the like can be considered.

### Apparatus Operation

Operation of the terminal apparatus will be described in detail.

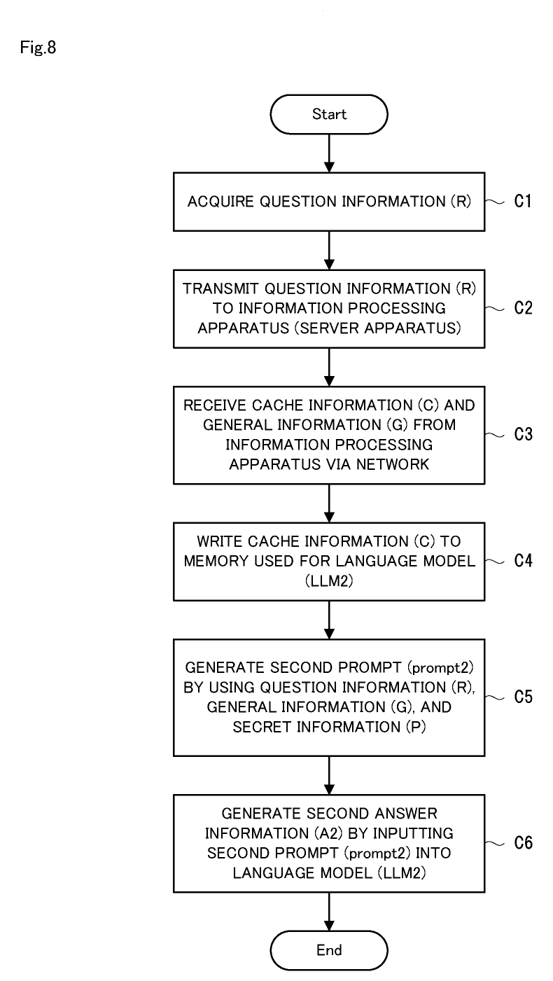

Next, operation of the terminal apparatus in the second example embodiment will be described with reference to FIG. 8. FIG. 8 is a diagram for describing an example of the operation of the terminal apparatus of the second example embodiment. The drawing will be appropriately referred to in the following description. In the second example embodiment, the terminal apparatus is caused to operate, whereby an information processing method of the terminal apparatus is implemented. Thus, description of the information processing method in the second example embodiment is substituted with the description of the operation of the terminal apparatus below.

As illustrated in FIG. 8, the transmission unit 61 first acquires at least the question information (R) representing a question input by the user using the operation unit 66 (step C1).

Next, the transmission unit 61 transmits the question information (R) to the information processing apparatus 70 (server apparatus) including the language model 76 (first language model: LLM1) for answering the question (step C2).

Next, the receiving unit 62 receives the cache information (C: cache) and the general information (G: general) from the information processing apparatus 70, the cache information being generated when the first answer information (A1 = LLM1(prompt1)) is generated by input of the first prompt (prompt1 = G + R) into the language model 76 (LLM1) and read from the memory used for the language model 76, the first prompt being generated by use of the question information (R) and the general information (G) related to the question information (R) (step C3).

Next, the writing unit 63 writes the cache information (C) to the memory used for the language model 67 (LLM2) (step C4).

Next, by using the question information (R), the general information (G), and the secret information (P) related to the question information set in advance, the prompt generation unit 64 generates the second prompt (prompt2 = G + R + P) (step C5).

Next, by inputting the second prompt (prompt2) into the language model 67 (LLM2), the answer generation unit 65 generates the second answer information (A2 = LLM2(prompt2)) (step C6). Thereafter, the second answer information (A2) is presented to the user by use of the user interface of the terminal apparatus 60.

Operation of the information processing apparatus (server apparatus) will be described in detail.

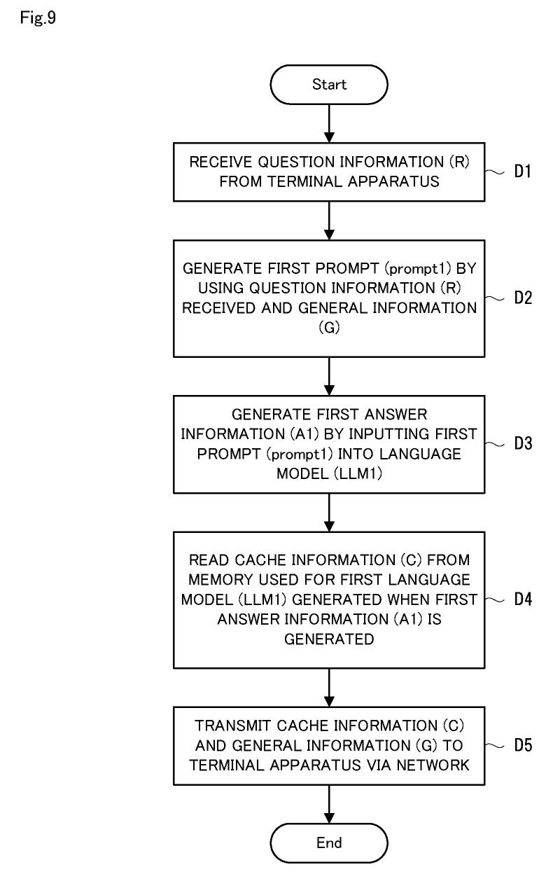

Next, operation of the information processing apparatus (server apparatus) in the second example embodiment will be described with reference to FIG. 9. FIG. 9 is a diagram for describing an example of the operation of the information processing apparatus (server apparatus) of the second example embodiment. The drawing will be appropriately referred to in the following description. In the second example embodiment, the information processing apparatus (server apparatus) is caused to operate, whereby the information processing method of the information processing apparatus (server apparatus) is implemented. Thus, description of the information processing method in the second example embodiment is substituted with the description of the operation of the information processing apparatus (server apparatus) below.

First, the receiving unit 71 receives the question information (R) from the terminal apparatus 60 via the network 30 (step D1).

Next, by using the question information (R) received and the general information (G) related to the question information (R), the prompt generation unit 73 generates the first prompt (prompt1 = G + R) (step D2).

Next, by inputting the first prompt (prompt1 = G + R) into the language model 76 (LLM1), the answer generation unit 74 generates the first answer information (A1 = LLM1(prompt1)) (step D3).

Next, the reading unit 75 reads the cache information (C) from the memory used for the language model 76 (LLM1), the cache information being generated when the first answer information (A1) is generated (step D4).

Next, the transmission unit 72 transmits the cache information (C) and the general information (G) to the terminal apparatus 60 via the network 30 (step D5).

### Effects of Second Example Embodiment

As described above, according to the second example embodiment, in the processing using the language model, the secret information is handled by the terminal apparatus without being transmitted to the cloud side (information processing apparatus (server apparatus)), so that it is possible to prevent leakage of the secret information.

On the cloud side, first, the first answer information is calculated by use of the question information and the general information, and information (cache information) in the memory (KV cache) used for the first language model, the information being generated when the first answer information is generated, is written to the memory (KV cache) used for the second language model of the terminal apparatus, so that it is possible to reduce the amount of processing for generating the cache information again on the terminal apparatus side.

### Second Example

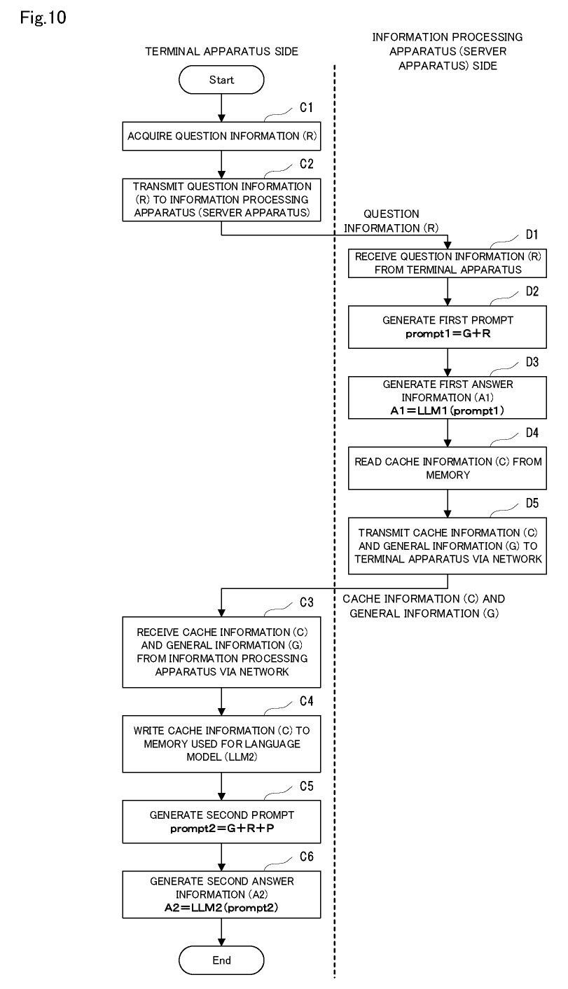

In a second example, with reference to FIG. 10, a description will be given of a case of requesting a determination in consideration of laws and further in consideration of company regulations. FIG. 10 is a diagram for describing an example of operation of the system of the second example embodiment.

Specifically, the general information (G) is a legal document database (DB) stored in advance in the storage unit 26. The legal document DB is, for example, enormous data of equal to or more than 60,000 words. The secret information (P) is a company regulation database (DB) stored in advance in the storage unit 17. The company regulation DB is data of, for example, 1000 words or the like.

In step C1, first, it is assumed that “Please tell me what I should be careful about when I want to do a side business” (25 words) is input as a question by use of the operation unit 66 of the terminal apparatus 60.

Next, in step C2, the transmission unit 61 of the terminal apparatus 60 transmits the question information (R) relevant to the question to the information processing apparatus 70 (server apparatus) via the network 30.

Next, in step D1, the receiving unit 71 of the information processing apparatus 70 (server apparatus) receives the question information (R) from the terminal apparatus 60 via the network 30.

Next, in step D2, by using the question information (R) received and the general information (G) related to the question information (R), the prompt generation unit 73 of the information processing apparatus 70 (server apparatus) generates the first prompt (prompt1 = G + R).

Next, in step D3, by inputting the first prompt (prompt1 = G + R) into the language model 76 (LLM1), the answer generation unit 74 of the information processing apparatus 70 (server apparatus) generates the first answer information (A1 = LLM1(prompt1)). The first answer information is, for example, “Tax return or the like... ” (200 words) or the like. The generation of the first answer information may be terminated halfway.

Next, in step D4, the reading unit 75 of the information processing apparatus 70 (server apparatus) reads the cache information (C) from the memory used for the language model 76 (LLM1), the cache information being generated when the first answer information (A1) is generated.

Next, in step D5, the transmission unit 72 of the information processing apparatus 70 (server apparatus) transmits the cache information (C) and the general information (G) to the terminal apparatus 60 via the network 30.

Next, in step C3, the receiving unit 62 of the terminal apparatus 60 receives the cache information (C) and the general information (G) from the information processing apparatus 70.

Next, in step C4, the writing unit 63 of the terminal apparatus 60 writes the cache information (C) to the memory used for the language model 67 (LLM2).

Next, in step C5, by using the question information (R), the general information (G), and the secret information (P) related to the question information set in advance, the prompt generation unit 64 of the terminal apparatus 60 generates the second prompt (prompt2 = G + R + P).

For example, a text in which legal documents related to tax return are cut out and listed for each of items is set as the general information (G), “Please tell me what I should be careful about when I want to do a side business” that is the question input into the terminal apparatus 60 is set as the question information (R), and a text in which documents of the Work Rules are listed is set as the secret information (P), and then the second prompt is generated. However, the second prompt is not limited to the above-described content.

Next, in step C6, by inputting the second prompt (prompt2) into the language model 67 (LLM2), the answer generation unit 65 of the terminal apparatus 60 generates the second answer information (A2 = LLM2 (prompt2)).

### Program

A program of the terminal apparatus will be described.

A program of the terminal apparatus in the second example embodiment only needs to be a program that causes a computer to execute steps C1 to C6 illustrated in FIG. 8. The program is installed on the computer and executed, whereby it is possible to implement the terminal apparatus and the information processing method in the second example embodiment. In this case, a processor of the computer functions as the writing unit 63, the prompt generation unit 64, the answer generation unit 65, the operation unit 66, and the language model 67, and performs processing.

The program of the terminal apparatus in the second example embodiment may be executed by a computer system including a plurality of computers. In this case, for example, each computer may function as any of the writing unit 63, the prompt generation unit 64, the answer generation unit 65, the operation unit 66, and the language model 67.

A program of the information processing apparatus (server apparatus) will be described.

A program of the information processing apparatus (server apparatus) in the second example embodiment only needs to be a program that causes a computer to execute steps B1 to B4 illustrated in FIG. 9. The program is installed on the computer and executed, whereby it is possible to implement the information processing apparatus (server apparatus) and the information processing method in the first example embodiment. In this case, a processor of the computer functions as the prompt generation unit 73, the answer generation unit 74, the reading unit 75, and the language model 76, and performs processing.

The program of the terminal apparatus in the second example embodiment may be executed by a computer system including a plurality of computers. In this case, for example, each computer may function as any of the prompt generation unit 73, the answer generation unit 74, the reading unit 75, and the language model 76.

### Physical Configuration

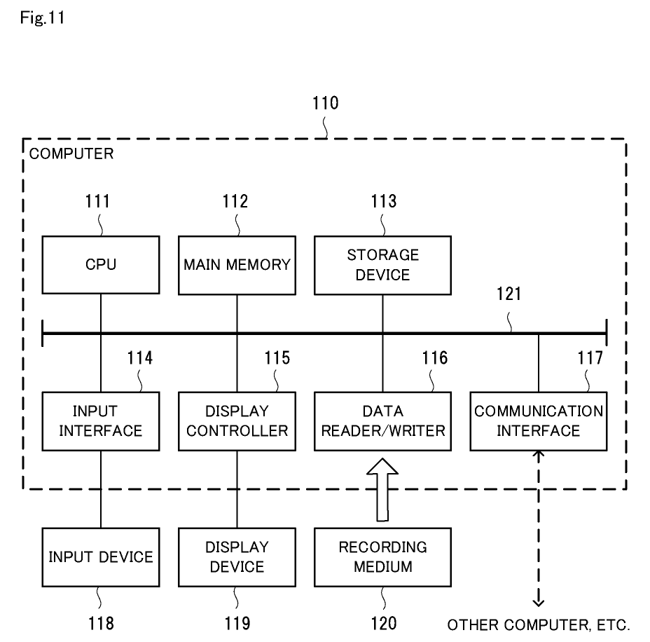

Here, with reference to FIG. 11, a description will be given of a computer that implements the terminal apparatus and the information processing apparatus (server apparatus) by executing the programs in the first and second example embodiments. FIG. 11 is a diagram for describing an example of the computer that implements the terminal apparatus and the information processing apparatus (server apparatus) in the first and second example embodiments.

As illustrated in FIG. 11, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to perform data communication with each other. The computer 110 may include a GPU or an FPGA in addition to the CPU 111 or instead of the CPU 111.

The CPU 111 loads the program in the example embodiment, which is stored in the storage device 113 and includes codes, into the main memory 112, and executes each code in a predetermined order to perform various operations. The main memory 112 is typically a volatile storage device such as a dynamic random access memory (DRAM).

The program in the example embodiment is provided in a state of being stored in a computer-readable recording medium 120. The program in the example embodiment may be distributed on the Internet connected via the communication interface 117.

Specific examples of the storage device 113 include a semiconductor storage device, such as a flash memory, in addition to a hard disk drive. The input interface 114 mediates data transmission between the CPU 111 and an input device 118 such as a keyboard or a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) or Secure Digital (SD), a magnetic recording medium such as a Flexible Disk, and an optical recording medium such as a Compact Disk Read Only Memory (CD-ROM).

The terminal apparatus and the information processing apparatus (server apparatus) in the first and second example embodiments can also be implemented by use of hardware relevant to each unit, for example, an electronic circuit, instead of a computer on which a program is installed. Furthermore, a part of the terminal apparatus and the information processing apparatus (server apparatus) may be implemented by a program, and the remaining part may be implemented by hardware. In the example embodiments, the computer is not limited to the computer illustrated in FIG. 11.

While the invention has been particularly shown and described with reference to example embodiments thereof, the invention is not limited to these example embodiments. Various modified examples that can be understood by those skilled in the art can be made to the configuration and details of the invention within the scope of the invention.

### Industrial Applicability

According to the above description, it is possible to handle the secret information only on the terminal apparatus side, and reduce the amount of processing by the terminal apparatus, in the processing using the language model. The present invention is useful in a field in which a language processing model is required.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

1. A terminal apparatus comprising:
a transmission means for transmitting at least question information representing a question input by a user using an input apparatus to an information processing apparatus including a first language model for answering the question;
a receiving means for receiving, from the information processing apparatus, first answer information obtained by input of a first prompt into the first language model, the first prompt being generated by use of the question information and general information related to the question information;
a prompt generation means for generating a second prompt by using the question information, the first answer information, and secret information related to the question information set in advance; and
an answer generation means for generating second answer information by inputting the second prompt into a second language model.

2. A system wherein
a terminal apparatus transmits at least question information representing a question input by a user using an input apparatus to a server apparatus including a first language model for answering the question,
the server apparatus:
receives the question information from the terminal apparatus;
generates a first prompt by using the question information and general information related to the question information;
generates first answer information by inputting the first prompt into the first language model; and
transmits the first answer information to the terminal apparatus, and
the terminal apparatus:
receives the first answer information from the server apparatus;
generates a second prompt by using the question information, the first answer information, and secret information related to the question information set in advance; and
generates second answer information by inputting the second prompt into a second language model.

3. A terminal apparatus comprising:
a transmission means for transmitting at least question information representing a question input by a user using an input apparatus to an information processing apparatus including a first language model for answering the question;
a receiving means for receiving cache information and general information from the information processing apparatus, the cache information being generated when first answer information is generated by input of a first prompt into the first language model and read from a memory used for the first language model, the first prompt being generated by use of the question information and the general information related to the question information;
a writing means for writing the cache information to a memory used for a second language model;
a prompt generation means for generating a second prompt by using the question information, the general information, and secret information related to the question information set in advance; and
an answer generation means for generating second answer information by inputting the second prompt into the second language model.

4. The terminal apparatus according to claim 3, wherein
the first language model and the second language model are identical language models, and the cache information is KV cache information.
